(19) United States
(12) Patent Application Publication
(10) Pub. No.: US 2026/0039194 A1
(43) Pub. Date: Feb. 5, 2026

(54) BATTERY CHARGING CIRCUIT AND METHODS FOR TRICKLE CHARGING AND PRECHARGING A DEAD MULTI-CELL-IN-SERIES BATTERY

(71) Applicant: QUALCOMM Incorporated, San Diego, CA (US)

(72) Inventors: Guoyong GUO, San Jose, CA (US); Cheong KUN, San Diego, CA (US); Chunping SONG, Palo Alto, CA (US)

(21) Appl. No.: 19/297,945

(22) Filed: Aug. 12, 2025

Related U.S. Application Data
(63) Continuation of application No. 17/336,075, filed on Jun. 1, 2021, now Pat. No. 12,388,361.
(60) Provisional application No. 63/033,356, filed on Jun. 2, 2020.

(51) Int. Cl. H02M 3/07; H01M 10/44; H02J 7/00; H02M 1/00; H02M 3/158

(52) U.S. Cl. CPC H02M 3/07; H01M 10/441; H02J 7/007182; H02M 3/072; H02J 7/0024; H02J 2207/20; H02M 1/0095; H02M 3/071; H02M 3/073; H02M 3/1582

(57) ABSTRACT

Methods and apparatus for trickle charging and precharging a dead multi-cell-in-series battery. One example battery charging circuit generally includes a charge pump circuit comprising a plurality of switches, being coupled to first and second power supply nodes, and being configured to multiply (or divide) a first voltage at the first power supply node to generate a second voltage at the second power supply node; a driver circuit configured to drive the plurality of switches in the charge pump circuit; and an arbiter having a first input coupled to the first power supply node, a second input coupled to the second power supply node, a third input coupled to a third power supply node having a third voltage, and an output coupled to a power supply terminal of the driver circuit. The arbiter is configured to select between the first, second, and third voltages to power the driver circuit.

### CROSS-REFERENCE TO RELATED APPLICATION(S)

The present application is a continuation of U.S. patent application Ser. No. 17/336,075, filed Jun. 1, 2021, which claims the benefit of and priority to U.S. Provisional Application No. 63/033,356, filed Jun. 2, 2020, each of which is hereby expressly incorporated by reference herein in its entirety as if fully set forth below and for all applicable purposes.

### TECHNICAL FIELD

Certain aspects of the present disclosure generally relate to electronic circuits and, more particularly, to methods and apparatus for charging a dead multi-cell-in-series battery.

### BACKGROUND

A voltage regulator ideally provides a constant direct current (DC) output voltage regardless of changes in load current or input voltage. Voltage regulators may be classified as linear regulators or switching regulators. While linear regulators tend to be relatively compact, many applications may benefit from the increased efficiency of a switching regulator. A linear regulator may be implemented by a low-dropout (LDO) regulator, for example. A switching regulator (also known as a “switching converter” or “switcher”) may be implemented, for example, by a switched-mode power supply (SMPS), such as a buck converter, a boost converter, a buck-boost converter, or a charge pump.

For example, a buck converter is a type of SMPS typically comprising: (1) a high-side switch coupled between a relatively higher voltage rail and a switching node, (2) a low-side switch coupled between the switching node and a relatively lower voltage rail, (3) and an inductor coupled between the switching node and a load (e.g., represented by a shunt capacitive element). The high-side and low-side switches are typically implemented with transistors, although the low-side switch may alternatively be implemented with a diode.

A charge pump is a type of SMPS typically comprising at least one switching device to control the connection of a supply voltage across a load through a capacitor. In a voltage doubler (also referred to as a “multiply-by-two (×2) charge pump”), for example, the capacitor of the charge pump circuit may initially be connected across the supply, charging the capacitor to the supply voltage. The charge pump circuit may then be reconfigured to connect the capacitor in series with the supply and the load, doubling the voltage across the load. This two-stage cycle is repeated at the switching frequency for the charge pump. Charge pumps may be used to multiply or divide voltages by integer or fractional amounts, depending on the circuit topology.

Power management integrated circuits (power management ICs or PMICs) are used for managing the power scheme of a host system and may include and/or control one or more voltage regulators (e.g., buck converters and/or charge pumps). A PMIC may be used in battery-operated devices, such as mobile phones, tablets, laptops, wearables, etc., to control the flow and direction of electrical power in the devices. The PMIC may perform a variety of functions for the device such as DC-to-DC conversion (e.g., using a voltage regulator as described above), battery charging, power-source selection, voltage scaling, power sequencing, etc.

### SUMMARY

The systems, methods, and devices of the disclosure each have several aspects, no single one of which is solely responsible for its desirable attributes. Without limiting the scope of this disclosure as expressed by the claims that follow, some features are discussed briefly below. After considering this discussion, and particularly after reading the section entitled “Detailed Description,” one will understand how the features of this disclosure provide the advantages described herein.

Certain aspects of the present disclosure generally relate to methods and apparatus for charging a dead multi-cell-in-series battery, such as trickle charging such a battery using a charge pump.

Certain aspects of the present disclosure are directed to a battery charging circuit. The battery charging circuit generally includes a charge pump circuit comprising a plurality of switches and a capacitive element, being coupled to a first power supply node and a second power supply node, and being configured to at least one of: multiply a first voltage at the first power supply node to generate a second voltage at the second power supply node; or divide the second voltage at the second power supply node to generate the first voltage at the first power supply node; a driver circuit coupled to the charge pump circuit and configured to drive the plurality of switches in the charge pump circuit; and an arbiter having a first input coupled to the first power supply node, a second input coupled to the second power supply node, a third input coupled to a third power supply node having a third voltage, and an output coupled to a power supply terminal of the driver circuit, the arbiter being configured to select between the first voltage, the second voltage, and the third voltage to power the driver circuit

Certain aspects of the present disclosure are directed to a power supply system comprising the battery charging circuit described herein. The power supply system further includes a power management circuit, the power management circuit having a switched-mode power supply circuit with an output coupled to the first power supply node of the battery charging circuit.

Certain aspects of the present disclosure are directed to a wireless device comprising the battery charging circuit described herein. The wireless device further includes a multi-cell battery coupled to the second power supply node of the battery charging circuit.

Certain aspects of the present disclosure are directed to a method of supplying power. The method generally includes selecting between a first voltage at a first power supply node, a second voltage at a second power supply node, and a third voltage at a third power supply node to power a driver circuit coupled to a charge pump circuit; and operating at least a portion of the driver circuit powered using the selected first, second, or third voltage.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of an example device comprising a power management system that includes a power supply circuit and a battery charging circuit, in accordance with certain aspects of the present disclosure.

FIG. 2A is a schematic diagram of an example power supply system capable of trickle charging a dead battery using a battery charging circuit with a trickle charger, a battery switch, and two alternative power supply rails.

FIG. 2B is a timing diagram illustrating trickle charging the dead battery using the power supply system of FIG. 2A.

FIG. 3A is a schematic diagram of an example power supply system capable of trickle charging a dead battery using a battery charging circuit with three alternative power supply rails and without a trickle charger or a battery switch, in accordance with certain aspects of the present disclosure.

FIG. 3B is a timing diagram illustrating trickle charging the dead battery using the power supply system of FIG. 3A, in accordance with certain aspects of the present disclosure.

FIG. 4 is a flow diagram of example operations for supplying power, in accordance with certain aspects of the present disclosure.

FIG. 5 is a flow diagram of example operations for supplying power, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure provide techniques and apparatus for charging a dead multi-cell-in-series battery, such as trickle charging such a battery using a charge pump.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### Example Device

It should be understood that aspects of the present disclosure may be used in a variety of applications. Although the present disclosure is not limited in this respect, the circuits disclosed herein may be used in any of various suitable apparatus, such as in the power supply, battery charging circuit, or power management circuit of a communication system, a video codec, audio equipment such as music players and microphones, a television, camera equipment, and test equipment such as an oscilloscope. Communication systems intended to be included within the scope of the present disclosure include, by way of example only, cellular radiotelephone communication systems, satellite communication systems, two-way radio communication systems, one-way pagers, two-way pagers, personal communication systems (PCS), personal digital assistants (PDAs), and the like.

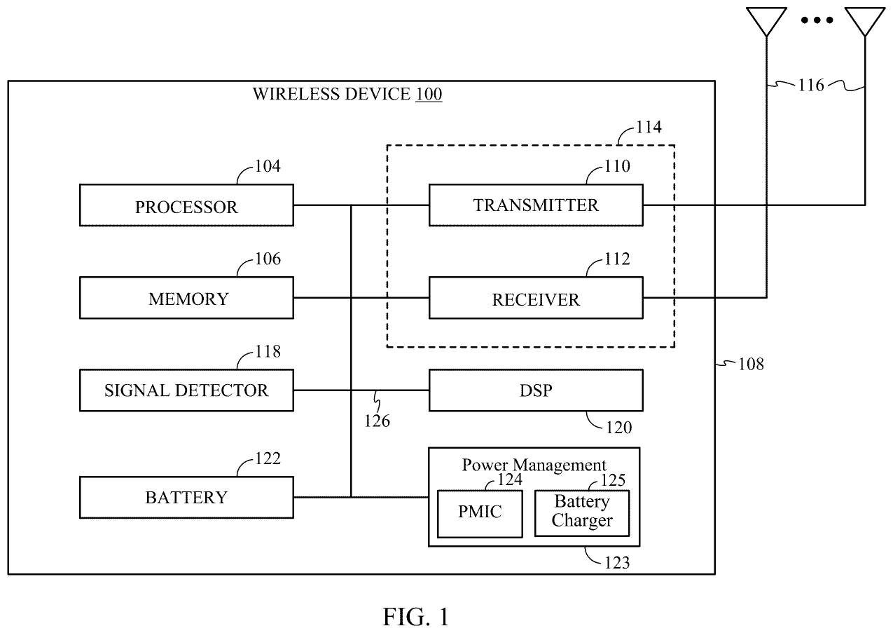

FIG. 1 illustrates an example device 100 in which aspects of the present disclosure may be implemented. The device 100 may be a battery-operated device such as a cellular phone, a PDA, a handheld device, a wireless device, a laptop computer, a tablet, a smartphone, a wearable device, etc.

The device 100 may include a processor 104 that controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106.

In certain aspects, the device 100 may also include a housing 108 that may include a transmitter 110 and a receiver 112 to allow transmission and reception of data between the device 100 and a remote location. For certain aspects, the transmitter 110 and receiver 112 may be combined into a transceiver 114. One or more antennas 116 may be attached or otherwise coupled to the housing 108 and electrically connected to the transceiver 114. The device 100 may also include (not shown) multiple transmitters, multiple receivers, and/or multiple transceivers.

The device 100 may also include a signal detector 118 that may be used in an effort to detect and quantify the level of signals received by the transceiver 114. The signal detector 118 may detect such signal parameters as total energy, energy per subcarrier per symbol, and power spectral density, among others. The device 100 may also include a digital signal processor (DSP) 120 for use in processing signals.

The device 100 may further include a battery 122, which may be used to power the various components of the device 100 (e.g., when another power source—such as a wall adapter or a wireless power charger—is unavailable). The battery 122 may comprise a single cell or multiple cells connected in series. The device 100 may also include a power management system 123 for managing the power from the battery 122, a wall adapter, and/or a wireless power charger to the various components of the device 100. The power management system 123 may perform a variety of functions for the device such as DC-to-DC conversion, battery charging, power-source selection, voltage scaling, power sequencing, etc. In certain aspects, the power management system 123 may include a power management integrated circuit (power management IC or PMIC) 124 and one or more power supply circuits, such as a battery charger 125, which may be controlled by the PMIC. For certain aspects, at least a portion of one or more of the power supply circuits may be integrated in the PMIC 124. The PMIC 124 and the one or more power supply circuits may include at least a portion of a switched-mode power supply (SMPS) circuit, which may be implemented by any of various suitable SMPS circuit topologies, such as a buck converter, a buck-boost converter, a three-level buck converter, or a charge pump, such as a multiply-by-two (×2) or multiply-by-three (×3) charge pump.

The various components of the device 100 may be coupled together by a bus system 126, which may include a power bus, a control signal bus, and/or a status signal bus in addition to a data bus.

### Example Trickle Charging Schemes

Battery charging systems (e.g., the battery charger 125 of FIG. 1) are trending towards higher charging current, which leads to the desire for higher efficiency converters that can operate over a wider battery voltage range. To reduce thermal issues and/or conserve power, it may be desirable to operate such battery charging systems with higher efficiency.

In one example parallel charging solution, the master charger is implemented based on a buck converter topology. The master charger is capable of charging the battery (e.g., the battery 122) and providing power by itself or may be paralleled with one or more slave chargers. Each of the slave chargers may be implemented, for example, as a switched-capacitor converter (e.g., a divide-by-two (Div2) charge pump) or a switched-mode power supply (SMPS) topology using an inductor (e.g., a buck converter). Charge pump converters may provide a more efficient alternative than buck converters.

Compared with single-cell (1S) battery charging, charging a two-cell-in-series (2S) battery stores two times the power in the battery with the same charging current, thereby offering double the charging rate. A power supply system for charging a 2S battery may include, for example, a buck charger followed by a boost charger, or a buck charger followed by a charge pump capable of voltage multiplying by two (λ2). Such a X2 charge pump may also be capable of dividing by two (Div2) when discharging the 2S battery in the opposite direction (i.e., in reverse). Hence, a battery charging circuit with this multiply-by-two and divide-by-two charge pump capability may be referred to as an “X2/D2” circuit or chip. The power source for the X2/D2 circuit may come from a first power supply node, which may come from a buck converter in a power management circuit (e.g., the PMIC 124), or from a second power supply node, which may come from the 2S battery.

When the 2S battery is dead, the battery may be recharged. However, trying to fast charge a dead battery may introduce a high current that may damage the battery and/or shorten the life of the battery. Therefore, trickle charging may be used to more slowly charge a dead battery. Trickle charging typically involves applying a continuous constant-current charge at a low rate.

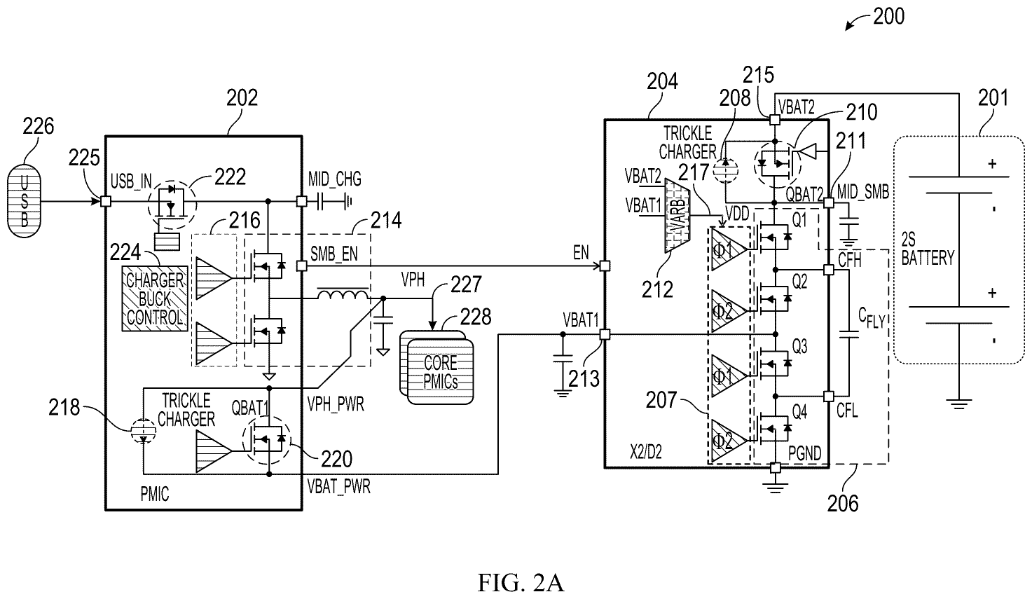

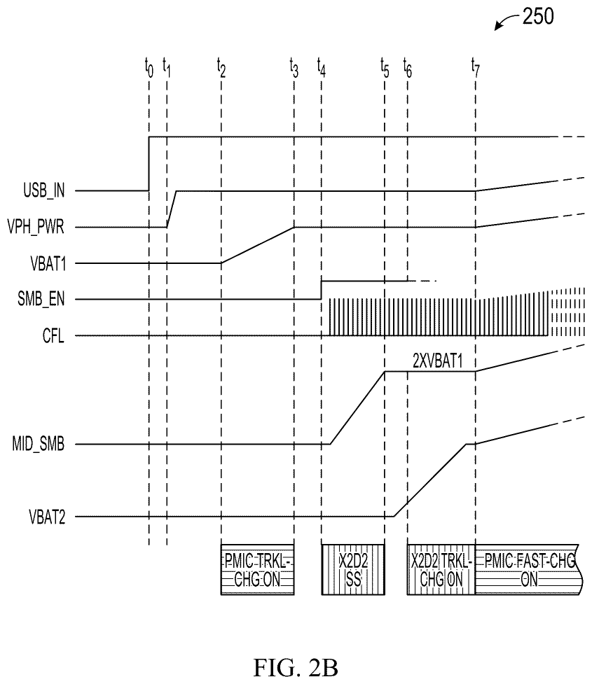

FIG. 2A is a schematic diagram of an example power supply system 200 capable of trickle charging a dead multi-cell battery 201 (e.g., a 2S battery). The power supply system 200 includes a power management circuit 202 (e.g., a PMIC 124) and a battery charging circuit 204 (e.g., battery charger 125, such as an X2/D2 chip).

The power management circuit 202 may include a switched-mode power supply (SMPS) 214, gate drivers 216, a first battery switch 220 (e.g., transistor QBAT1), a reverse blocking transistor 222, and control logic 224. For certain aspects, the SMPS 214 may also include an optional trickle charger 218 in parallel with the first battery switch 220. The SMPS 214 may be implemented by any of various suitable switching regulators, such as a two-level buck converter (as illustrated in FIG. 2A) or a three-level buck converter. The control logic 224 may control the gate drivers 216, which may provide level-shifted outputs to the gates of the power transistors implementing the SMPS 214. The control logic 224 may also control the reverse blocking transistor 222 and/or the first battery switch 220. The SMPS 214 may receive power at an input power node 225 (labeled “USB_IN”) from one of multiple potential power sources, such as a wall adapter or other power cable (e.g., a Universal Serial Bus (USB) adapter) connected via USB port 226 or a wireless power charger (not shown). The output of the SMPS 214 at system power node 227 (labeled “VPH,” but also referred to as “VPH_PWR”) may provide power to one or more core PMICs 228 and/or other circuits within a device (e.g., device 100). The first battery switch 220 may be coupled between the system power node 227 and a first power supply node 213 (labeled “VBAT1,” but also referred to as “VBAT_PWR”) for the battery charging circuit 204.

The battery charging circuit 204 in FIG. 2A may include a charge pump circuit 206, a driver circuit 207, a trickle charger 208, a second battery switch 210 (e.g., transistor QBAT2), and an arbiter 212. The second battery switch 210 and the trickle charger 208 may be coupled in parallel between the charge pump circuit 206 and a second power supply node 215 (labeled “VBAT2”) for the battery charging circuit 204. The second power supply node 214 may be coupled to the battery 201. The arbiter 212 may be configured to select between two alternative power supply rails (e.g., VBAT1 and VBAT2) for powering gate drivers in the driver circuit 207, as described below.

While the charge pump circuit 206 is generally described herein with the example of an X2/D2 charge pump, it is to be understood that the charge pump circuit 206 may be implemented with other configurations, such as an X3/D3 charge pump. The charge pump circuit 206 may include a plurality of switches (which may be implemented by a first transistor Q1, a second transistor Q2, a third transistor Q3, and a fourth transistor Q4 as shown) and a flying capacitive element Cfly. Transistor Q2 may be coupled to transistor Q1 via a first node (labeled “CFH”), transistor Q3 may be coupled to transistor Q2 via a second node (which may also be or be coupled to the first power supply node 213 having voltage VBAT1), and transistor Q4 may be coupled to transistor Q3 via a third node (labeled “CFL”). For certain aspects, the transistors Q1-Q4 may be implemented as n-type metal-oxide-semiconductor (NMOS) transistors, as illustrated in FIG. 2A. In this case, the drain of transistor Q2 may be coupled to the source of transistor Q1, the drain of transistor Q3 may be coupled to the source of transistor Q2, and the drain of transistor Q4 may be coupled to the source of transistor Q3. The source of transistor Q4 may be coupled to a reference potential node (e.g., electrical ground, labeled “PGND”) for the circuit. The flying capacitive element Cfly may have a first terminal coupled to the first node (CFH) and have a second terminal coupled to the third node (CFL).

Control logic (not shown) may control operation of the charge pump circuit 206 in the battery charger. For example, the control logic may control operation of transistors Q1-Q4 via output signals to the inputs of respective gate drivers in the driver circuit 207. The outputs of the gate drivers are coupled to respective gates of transistors Q1-Q4. The gate drivers may each receive power at a power supply terminal coupled to a common power supply node 217 (labeled “VDD”). Inputs to the arbiter 212 may be coupled to the first power supply node 213 (VBAT1) and to the second power supply node 215 (VBAT2), and the control logic may control the arbiter 212 to select which power level to output at the common power supply node 217.

The control logic may control operation of the charge pump circuit 206 to cycle through different phases @1 and 2, with various combinations of transistors Q1-Q4 in different open and closed states. During Ø2, transistors Q2 and Q4 are closed, while transistor Q1 and Q3 are open, thereby charging flying capacitive element Cfly to VBAT1 from CFH to CFL. During @1, transistors Q1 and Q3 are closed, while transistors Q2 and Q4 are open, thereby bootstrapping VBAT2 at the second power supply node 215 to 2*VBAT1 by adding the voltage across the flying capacitive element Cfly to the voltage at the first power supply node 213. In this manner, the charge pump circuit 206 acts as an X2 charge pump.

FIG. 2B is a timing diagram 250 illustrating trickle charging a dead multi-cell battery 201 (e.g., a dead 2S battery) using the power supply system 200 of FIG. 2A. Initially, VBAT1 and VBAT2=0 V (dead battery), and then at time to, a power source capable of charging the multi-cell battery 201 is provided. For example, a user may plug in a wall adapter or other power cable (e.g., USB)). At time t₁, the power management circuit 202 may bring up VPH_PWR to boot the system, using the buck converter illustrated in FIG. 2A, for example. For certain aspects, the power management circuit 202 trickle charges up VBAT_PWR (VBAT1 for the battery charger) starting at time t₂ using the trickle charger 218 in the power management circuit. For other aspects, the power management circuit 202 may quickly bring up VBAT_PWR (VBAT1) (e.g., without using the trickle charger 218 or when the trickle charger is not present).

The battery charging circuit 204 may have an undervoltage lockout (UVLO) threshold voltage. At time t₃ when VBAT1 is greater than the UVLO threshold, the power management circuit 202 may enable the battery charging circuit 204 (via transition of an enable signal, such as SMB_EN, at time t₄) to soft start and bring up an intermediate voltage (e.g., MID_SMB) at node 211, with the second battery switch 210 open (e.g., with transistor QBAT2 off). For certain aspects, the battery charging circuit 204 may most likely not directly soft-start into the dead multi-cell battery 201. Rather, trickle charging the multi-cell battery 201 may utilize a well-controlled low current. After the intermediate voltage (e.g., MID_SMB) reaches 2×VBAT1 for a 2S battery (or N×VBAT1 for a battery with N cells) at time t₅, the trickle charger 208 may be turned on at time t₆ to trickle charge the multi-cell battery 201 and bring up VBAT2 (i.e., increase the voltage of VBAT2). After VBAT2 reaches 2×VBAT1 for a 2S battery (or N×VBAT1 for battery with N cells), the battery charging circuit 204 may close the second battery switch (e.g., turn on transistor QBAT2) at time t₇ and may notify the power management circuit 202 to start normal charging (e.g., fast charging). Therefore, trickle charging in this manner involves four states: power management circuit trickle charging between times t₂ and t₃, battery charger soft start between times t₄ and t₅, battery charger trickle charging between times t₆ and t₇, and normal charging (e.g., fast charging) after time t₇.

Trickle charging using the power supply system 200 may not be as ideal as possible. For example, the battery charging circuit 204 in FIG. 2A has a second battery switch 210 (e.g., transistor QBAT2), which occupies extra area. Furthermore, the on-resistance of transistor QBAT2 may be associated with power loss during discharging of the multi-cell battery 201. In other words, when the multi-cell battery 201 is powering the device (providing power to the system power node 227 (VPH_PWR)) instead of a wall adapter, USB, or other external source), the on-resistance of transistor QBAT2 dissipates some power. Furthermore, the battery charging circuit 204 in FIG. 2A has a trickle charger 208, which occupies semiconductor space and adds costs to the battery charging circuit. Moreover, this trickle-charging scheme may be considered to be complicated, involving back-and-forth handshaking between the power management circuit 202 and the battery charging circuit 204.

Accordingly, certain aspects of the present disclosure provide techniques and apparatus for trickle charging a multi-cell-in-series battery with a battery charger that lacks a trickle charger and a battery switch (e.g., transistor QBAT2). Instead, the battery charger may be provided with three alternative power supply rails.

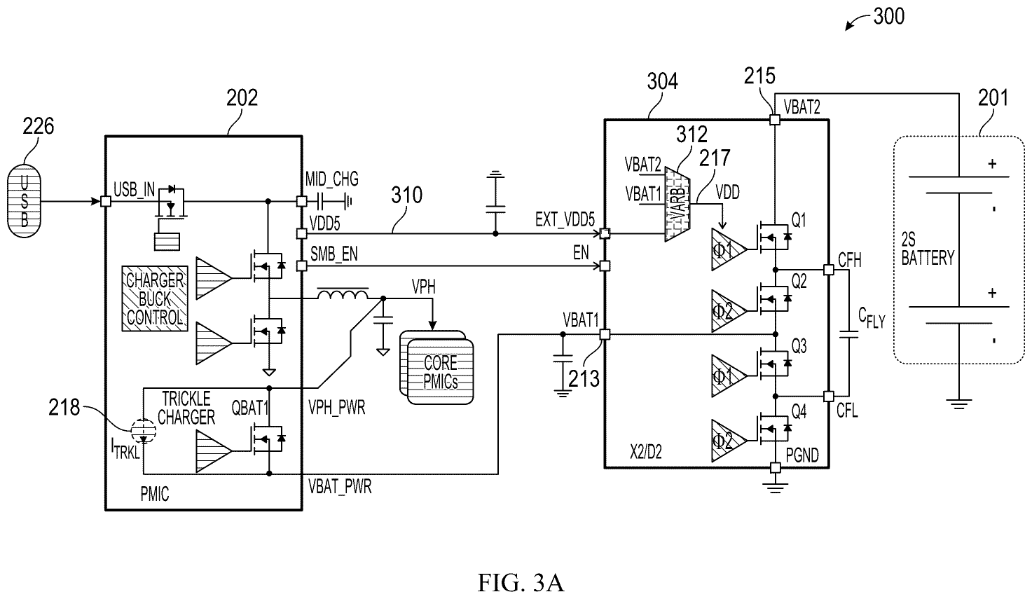

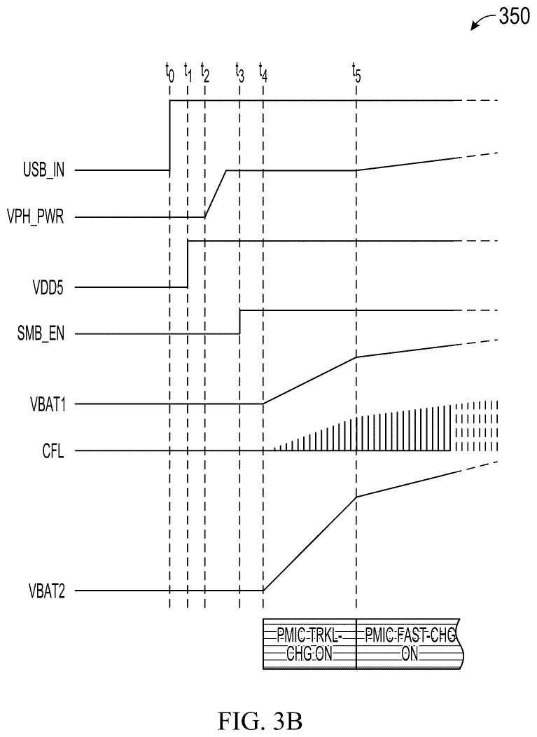

FIG. 3A is a schematic diagram of an example power supply system 300, in accordance with certain aspects of the present disclosure. As shown, the example power supply system 300 is capable of trickle charging a dead two-cell-in-series (2S) battery, although it is to be understand that the scope of the present disclosure includes batteries with more than two cells (e.g., three-cell-in-series (3S), four-cell-in-series (4S) batteries, or n-cell-in-series, where n is any integer greater than 1) and a battery charging circuit (e.g., X3D3, X4D4, or XnDn) capable of charging and/or discharging such an n-cell-in-series battery.

In the power supply system 300, the battery charging circuit 304 is provided with a third power supply voltage node 310 (labeled “VDD5”), which may be used during trickle charging of the dead battery 201. When both the first power supply voltage (e.g., VBAT1) and the second power supply voltage (e.g., VBAT2) are low, this third power supply voltage (VDD5) can supply the analog and digital circuits of the battery charging circuit 304 to allow operation thereof. This third power supply voltage may be provided from the power management circuit 202 (e.g., the PMIC 124) or may be provided from a power source (e.g., an LDO or SMPS (buck, boost, etc.) outside of the power management circuit. As an example, the third power supply voltage may be the same as the driver power supply for the power management circuit's own SMPS (e.g., VDD5 may be used to power the gate drivers 216).

The battery charging circuit 304 in FIG. 3A may include an arbiter 312 configured to select between three alternative power supply rails (e.g., VBAT1, VBAT2, and VDD5). Control logic (not shown) may control the arbiter 312 to select which power level to output at the common power supply node 217. However, the battery charging circuit 304 in FIG. 3A may not include a trickle charger (e.g., trickle charger 208) or a battery switch (e.g., transistor QBAT2). Rather, the drain of transistor Q1 may be coupled to the second power supply node 215 (VBAT2).

FIG. 3B is a timing diagram 350 illustrating trickle charging a dead multi-cell battery 201 (e.g., a dead 2S battery) using the power supply system 300 of FIG. 3A, in accordance with certain aspects of the present disclosure. Initially, VBAT1 and VBAT2=0 V (dead battery), and then at time to, a power source capable of charging the multi-cell battery 201 is provided. For example, a user may plug in a wall adapter or other power cable (e.g., USB). The third power supply voltage (e.g., VDD5) may be generated at time t₁. For certain aspects, the power management circuit 202 generates the third power supply voltage, while in other aspects, the third power supply voltage is supplied by another circuit. At time t₂ (which may occur before or after time t₁), the power management circuit 202 may bring up VPH_PWR to boot the system, using the buck converter of FIG. 3A, for example. At time t₃, the power management circuit 202 may also enable the battery charging circuit 304 with the transition of an enable signal (e.g., SMB_EN changing from logic low to logic high). The power management circuit 202 trickle charges up VBAT_PWR (VBAT1 for the battery charger) starting at time t₄ using the trickle charger 218, with a trickle charge current I_{TRKL}. Concurrently with VBAT_PWR (VBAT1) being trickle charged, the battery charging circuit 304 operates with the third supply voltage (VDD5) and trickle charges the multi-cell battery 201 with half the trickle charge current (I_{TRKL}/2), which also slowly brings up VBAT2. When the second power supply voltage (e.g., VBAT2) reaches the fast-charge threshold (e.g., 2×VBAT1) at time t₅, fast charging may begin. Therefore, trickle charging in this manner involves two states: power management circuit trickle charging simultaneously with battery charging circuit trickle charging between times t₄ and t₅, followed by normal charging (e.g., fast charging) after time t₅.

Trickle charging using the power supply system 300 of FIG. 3A may provide some advantages over trickle charging using the power supply system 200 of FIG. 2A. For example, no battery switch (e.g., transistor QBAT2) is used in the battery charging circuit 304, thereby saving the area consumption and power loss during discharging of the battery 201. Furthermore, no trickle charger is used in the battery charging circuit 304, thus reducing the occupied semiconductor area and cost. Moreover, this trickle-charging scheme in power supply system 300 may be considered to be simpler and more straightforward, without the back-and-forth handshaking between the power management circuit and the battery charging circuit.

### Example Operations

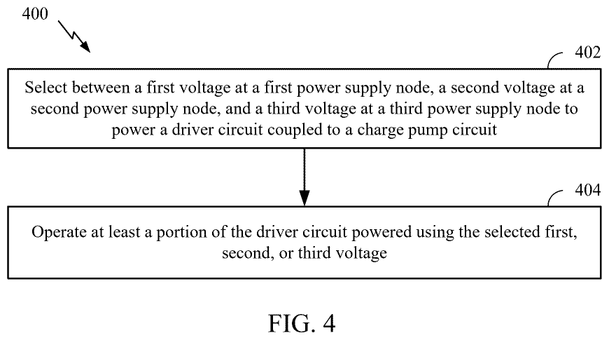

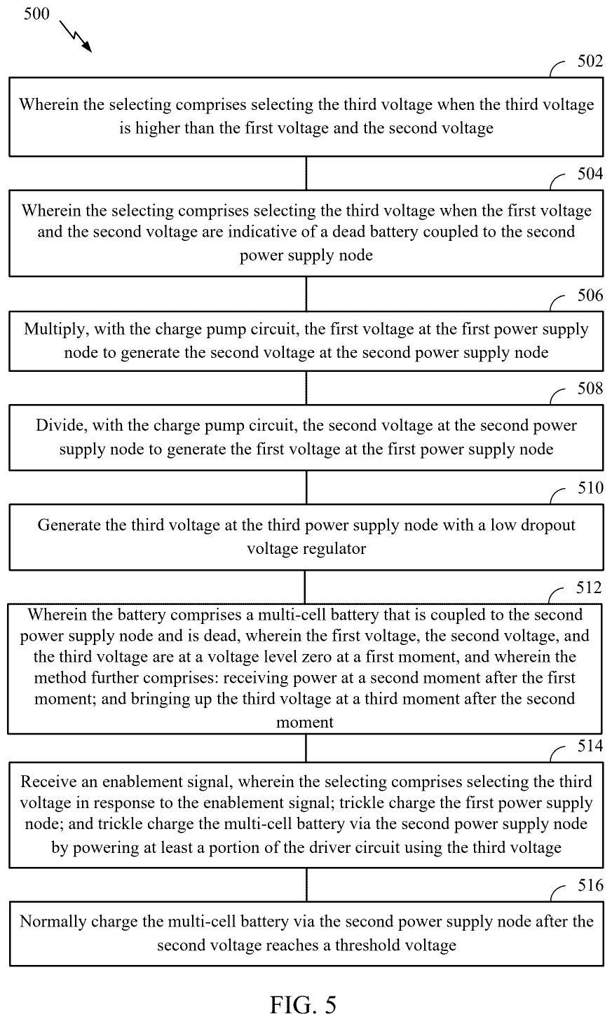

FIG. 4 is a flow diagram of example operations 400 for supplying power, in accordance with certain aspects of the present disclosure. The operations 400 may be performed by a power supply system (e.g., the power supply system 300 of FIG. 3A). FIG. 5 is a flow diagram of example operations 500 for supplying power, in accordance with certain aspects of the present disclosure.

The operations 400 may begin, at block 402, with the power supply system selecting between a first voltage (e.g., VBAT1) at a first power supply node (e.g., first power supply node 213), a second voltage (e.g., VBAT2) at a second power supply node (e.g., second power supply node 215), and a third voltage (e.g., VDD5) at a third power supply node (e.g., third power supply voltage node 310) to power a driver circuit (e.g., driver circuit 207) coupled to a charge pump circuit (e.g., charge pump circuit 206). At block 404, the power supply system may operate at least a portion of the driver circuit (e.g., gate drivers for transistors Q1 and Q2), which may be powered using the selected first, second, or third voltage.

According to certain aspects, the selecting at block 402 includes selecting the third voltage when the third voltage is higher than the first voltage and the second voltage (e.g., block 502).

According to certain aspects, the selecting at block 402 includes selecting the third voltage when the first voltage and the second voltage are indicative of a dead battery (e.g., multi-cell battery 201) coupled to the second power supply node (e.g., block 504).

According to certain aspects, the operations further involve at least one of: the charge pump circuit multiplying the first voltage at the first power supply node to generate the second voltage at the second power supply node (e.g., block 506); or the charge pump circuit dividing the second voltage at the second power supply node to generate the first voltage at the first power supply node (e.g., block 508).

According to certain aspects, the operations 400 further include generating the third voltage at the third power supply node with a voltage regulator (e.g., an LDO, block 510).

According to certain aspects (e.g., block 512), a multi-cell battery (e.g., multi-cell battery 201) coupled to the second power supply node is dead. In this case, the first, second, and third voltages may be zero at a first moment (e.g., at a time before time t₀). The operations 400 may further involve receiving power at a second moment (e.g., at time t₀) after the first moment and bringing up the third voltage at a third moment (e.g., at time t₁) after the second moment. For certain aspects, the operations 400 further include receiving an enablement signal (e.g., SMB_EN). In this case, the selecting at block 402 may involve selecting the third voltage in response to the enablement signal. For certain aspects (e.g., block 514), the operations 400 may further include trickle charging the first power supply node and trickle charging the battery via the second power supply node by powering at least a portion of the driver circuit using the third voltage. For certain aspects (e.g., block 516), the operations 400 may further include normally charging (e.g., fast charging, as opposed to trickle charging) the battery via the second power supply node after the second voltage reaches a threshold voltage (e.g., 2×VBAT1).

### Example Aspects

In addition to the various aspects described above, specific combinations of aspects are within the scope of the disclosure, some of which are detailed below:

Aspect 1: A battery charging circuit comprising: a charge pump circuit comprising a plurality of switches and a capacitive element, being coupled to a first power supply node and a second power supply node, and being configured to at least one of: multiply a first voltage at the first power supply node to generate a second voltage at the second power supply node; or divide the second voltage at the second power supply node to generate the first voltage at the first power supply node; a driver circuit coupled to the charge pump circuit and configured to drive the plurality of switches in the charge pump circuit; and an arbiter having a first input coupled to the first power supply node, a second input coupled to the second power supply node, a third input coupled to a third power supply node having a third voltage, and an output coupled to a power supply terminal of the driver circuit, the arbiter being configured to select between the first voltage, the second voltage, and the third voltage to power the driver circuit.

Aspect 2: The battery charging circuit of Aspect 1, wherein the arbiter is configured to select the third voltage when the third voltage is higher than the first voltage and the second voltage.

Aspect 3: The battery charging circuit of Aspect 1 or 2, wherein the arbiter is configured to select the third voltage when the first voltage and the second voltage are indicative of a dead battery coupled to the second power supply node.

Aspect 4: The battery charging circuit of any preceding Aspect, wherein the plurality of switches in the charge pump circuit comprises: a first switch coupled between the second power supply node and a first terminal of the capacitive element; a second switch coupled in series with the first switch and coupled between the first terminal of the capacitive element and the first power supply node; a third switch coupled in series with the second switch and coupled between the first power supply node and a second terminal of the capacitive element; and a fourth switch coupled in series with the third switch and coupled between the second terminal of the capacitive element and a reference potential node.

Aspect 5: The battery charging circuit of Aspect 4, wherein the first switch is connected to the second power supply node.

Aspect 6: The battery charging circuit of Aspect 4 or 5, wherein the battery charging circuit lacks a trickle charger between the first switch and the second power supply node.

Aspect 7: The battery charging circuit of any of Aspects 4-6, wherein the battery charging circuit lacks a fifth switch between the first switch and the second power supply node.

Aspect 8: The battery charging circuit of any of Aspects 4-7, wherein: the first, second, third, and fourth switches are implemented by first, second, third, and fourth transistors, respectively; a drain of the second transistor is coupled to a source of the first transistor; a drain of the third transistor is coupled to a source of the second transistor; and a drain of the fourth transistor is coupled to a source of the third transistor.

Aspect 9: The battery charging circuit of Aspect 8, wherein the first, second, third, and fourth transistors comprise n-type metal-oxide-semiconductor (NMOS) transistors.

Aspect 10: The battery charging circuit of any preceding Aspect, wherein the second power supply node is configured to couple to a terminal of a multi-cell battery.

Aspect 11: The battery charging circuit of any preceding Aspect, wherein the first power supply node is configured to couple to an output of a switched-mode power supply circuit.

Aspect 12: The battery charging circuit of any preceding Aspect, wherein the charge pump circuit is configured to at least one of: double the first voltage at the first power supply node to generate the second voltage at the second power supply node; or half the second voltage at the second power supply node to generate the first voltage at the first power supply node.

Aspect 13: A power supply system comprising the battery charging circuit of any of Aspects 1-10 and 12, the power supply system further comprising a power management circuit, the power management circuit having a switched-mode power supply circuit with an output coupled to the first power supply node of the battery charging circuit.

Aspect 14: The power supply system of Aspect 13, further comprising a voltage regulator having an output coupled to the third power supply node and configured to generate the third voltage.

Aspect 15: The power supply system of Aspect 13, wherein the power management circuit is configured to generate the third voltage.

Aspect 16: The power supply system of any of Aspects 13-15, further comprising a switch coupled between the output of the switched-mode power supply circuit and the first power supply node.

Aspect 17: The power supply system of Aspect 16, further comprising a trickle charger coupled in parallel with the switch and coupled between the output of the switched-mode power supply circuit and the first power supply node.

Aspect 18: A wireless device comprising the battery charging circuit of any of Aspects 1-9, 11, and 12, the wireless device further comprising a multi-cell battery coupled to the second power supply node of the battery charging circuit.

Aspect 19: A method of supplying power, comprising: selecting between a first voltage at a first power supply node, a second voltage at a second power supply node, and a third voltage at a third power supply node to power a driver circuit coupled to a charge pump circuit; and operating at least a portion of the driver circuit powered using the selected first, second, or third voltage.

Aspect 20: The method of Aspect 19, wherein the selecting comprises selecting the third voltage when the third voltage is higher than the first voltage and the second voltage.

Aspect 21: The method of Aspect 19 or 20, wherein the selecting comprises selecting the third voltage when the first voltage and the second voltage are indicative of a dead battery coupled to the second power supply node.

Aspect 22: The method of any of Aspects 19-21, further comprising multiplying, with the charge pump circuit, the first voltage at the first power supply node to generate the second voltage at the second power supply node.

Aspect 23: The method of any of Aspects 19-21, further comprising dividing, with the charge pump circuit, the second voltage at the second power supply node to generate the first voltage at the first power supply node.

Aspect 24: The method of any of Aspects 19-23, further comprising generating the third voltage at the third power supply node with a low dropout voltage regulator.

Aspect 25: The method of any of Aspects 19, 20, and 22-24, wherein a multi-cell battery coupled to the second power supply node is dead, wherein the first, second, and third voltages are zero at a first moment, and wherein the method further comprises: receiving power at a second moment after the first moment; and bringing up the third voltage at a third moment after the second moment.

Aspect 26: The method of Aspect 25, further comprising: receiving an enablement signal, wherein the selecting comprises selecting the third voltage in response to the enablement signal; trickle charging the first power supply node; and trickle charging the battery via the second power supply node by powering at least a portion of the driver circuit using the third voltage.

Aspect 27: The method of Aspect 26, further comprising normally charging the battery via the second power supply node after the second voltage reaches a threshold voltage.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes and variations may be made in the arrangement, operation, and details of the methods and apparatus described above without departing from the scope of the claims.

What is claimed is:

1. A power supply system comprising:
a charge pump circuit;
a trickle charger configured to trickle charge, during a time period, a first power supply node coupled to the charge pump circuit; and
a battery charging circuit configured to trickle charge, during the time period concurrently with the trickle charging of the first power supply node, a second power supply node that is coupled to the charge pump circuit and that is for coupling to a terminal of a battery.

2. The power supply system of claim 1, wherein a first voltage at the first power supply node and a second voltage at the second power supply node are at a same voltage level at a beginning of the time period.

3. The power supply system of claim 1, wherein the battery charging circuit is further configured to, when a first voltage at the second power supply node reaches a threshold voltage level at an end of the time period, normally charge the battery via the second power supply node.

4. The power supply system of claim 3, wherein the threshold voltage level is double a second voltage at the first power supply node.

5. The power supply system of claim 1, wherein the battery comprises a multi-cell battery that is coupled to the second power supply node and is dead at a beginning of the time period.

6. The power supply system of claim 1, wherein the charge pump circuit is configured to multiply a first voltage at the first power supply node to generate a second voltage at the second power supply node.

7. The power supply system of claim 1, wherein the charge pump circuit is configured to divide a first voltage at the second power supply node to generate a second voltage at the first power supply node.

8. The power supply system of claim 1, further comprising:
a driver circuit coupled to the charge pump circuit; and
a voltage regulator configured to generate a voltage at a third power supply node prior to a beginning of the time period, wherein the third power supply node is coupled to a power supply input of the driver circuit.

9. The power supply system of claim 1, further comprising a driver circuit, wherein the charge pump circuit comprises a plurality of switches and a capacitive element and wherein the driver circuit is configured to drive at least one switch of the plurality of switches in the charge pump circuit.

10. The power supply system of claim 9, wherein the plurality of switches comprises:
a first switch coupled between the second power supply node and a first terminal of the capacitive element;
a second switch coupled in series with the first switch and coupled between the first terminal of the capacitive element and the first power supply node;
a third switch coupled in series with the second switch and coupled between the first power supply node and a second terminal of the capacitive element; and
a fourth switch coupled in series with the third switch and coupled between the second terminal of the capacitive element and a reference potential node of the battery charging circuit.

11. The power supply system of claim 1, further comprising a power management circuit that includes the trickle charger and a switched-mode power supply circuit with an output coupled to the first power supply node.

12. The power supply system of claim 11, further comprising a driver circuit coupled to the charge pump circuit, wherein the power management circuit is configured to generate a voltage at a third power supply node prior to a beginning of the time period and wherein the third power supply node is coupled to a power supply input of the driver circuit.

13. The power supply system of claim 1, wherein:
the trickle charger is configured to trickle charge the first power supply node with a first charging current;
the battery charging circuit is configured to trickle charge the second power supply node with a second charging current; and
the second charging current is half of the first charging current.

14. The power supply system of claim 1, wherein the battery charging circuit is configured to trickle charge the second power supply node without using the trickle charger or any other trickle charger.

15. A power supply system comprising:
a charge pump circuit;
a trickle charger configured to trickle charge, during a time period, a first power supply node coupled to the charge pump circuit; and
a battery charging circuit configured to:
trickle charge, during the time period concurrently with the trickle charging of the first power supply node, a second power supply node that is coupled to the charge pump circuit and that is for coupling to a terminal of a battery; and
after one or more conditions are met indicating an end of the time period, normally charge the battery via the second power supply node.

16. The power supply system of claim 15, wherein a first voltage at the first power supply node and a second voltage at the second power supply node are at a same voltage level at a beginning of the time period.

17. The power supply system of claim 15, wherein the one or more conditions comprise a voltage of the second power supply node reaching a threshold voltage level at the end of the time period.

18. A method of supplying power, comprising:
trickle charging, using a trickle charger and during a time period, a first power supply node coupled to a charge pump circuit; and
trickle charging, using a battery charging circuit and during the time period concurrently with trickle charging the first power supply node, a second power supply node that is coupled to the charge pump circuit and that is for coupling to a terminal of a battery.

19. The method of claim 18, wherein a first voltage at the first power supply node and a second voltage at the second power supply node are at a same voltage level at a beginning of the time period.

20. The method of claim 18, further comprising, when a first voltage at the second power supply node reaches a threshold voltage level at an end of the time period, normally charging, using the battery charging circuit, the battery via the second power supply node.
